(19) United States
(12) Patent Application Publication
(10) Pub. No.: US 2022/0213908 A1
(43) Pub. Date: Jul. 7, 2022

(54) DRINKING STRAW ASSEMBLY AND RELATED METHODS

(71) Applicant: Lucero Anguiano, Chico, CA (US)

(72) Inventor: Lucero Anguiano, Chico, CA (US)

(21) Appl. No.: 17/702,782

(22) Filed: Mar. 23, 2022

Related U.S. Application Data
(63) Continuation-in-part of application No. 17/574,575, filed on Jan. 13, 2022.
Application No. 17/574,575 is a continuation-in-part of application No. 29/718,128, filed on Dec. 20, 2019, now Pat. No. D942793.
(60) Provisional application No. 63/137,138, filed on Jan. 13, 2021.

(51) Int. Cl. F16B 2/06; A47G 21/18

(52) U.S. Cl. CPC F16B 2/06; A47G 21/18

(57) ABSTRACT

The present disclosure provides a washable straw including a plurality of connectable portions that me connected by at least one clasp. The connectable portions allow the straw to be opened or separated to allow for thorough cleaning and avoid the buildup or bacteria, mold, or other contaminants that cannot be removed in conventional straw designs.

### FIELD OF THE INVENTION

The present invention relates to improved drinking straw design and related methods. More specifically, the present invention relates to an assembly-style drinking straw that allows for the straw to be effectively washed and sanitized for repeated use.

### SUMMARY OF THE INVENTION

Modern consumers are more environmentally conscious and desire to utilize reusable products to reduce the overall amount of waste that they generate. There are reusable drink cups that have been developed to accommodate consumers' desires for reusable drink and food containers. These drink cups have become prevalent and some are designed to be used with a straw (e.g., they may have a lid that includes a hole for accepting a straw). However, the straws that typically come with these drink cups quickly become unsanitary because it is difficult to access the interior of these straws, and bacteria and debris can accumulate inside the straw, as a result.

The present invention provides an assembly-style straw for repeated use. The straw may include at least two separable portions held together by a connecting mechanism, allowing the straw to be separated into separate parts so that the interior of the straw can be cleaned. The novel design of the new straw addresses the design drawbacks of existing washable, reusable straw designs.

The present invention provides a straw assembly that includes two longitudinal sections that connect to complete cylinder of the straw. The assembled and disassembled straw has a first body portion that is a portion of a cylinder and a predetermined thickness and a second body portion complementary to the first body portion that may be connected to the first body portion to form a complete cylindrical section of the straw. In some embodiments, the first body portion may include a first connecting device present on an edge thereof, and the second body portion may include a second connecting device present on an edge of the second body portion. The first connecting device and the second connecting device may be arranged in a manner that they are aligned with the first body portion and the second body portion are aligned and connected in a functioning, cylindrical straw configuration. However, it is contemplated in the present invention that the perimeter shape of the straw may have other shapes, including polygonal (e.g., triangular, rectangular, pentagonal, hexagonal, etc.), elliptical, and irregular shapes.

The connecting mechanism of the presently disclosed assembly-style straw may be a magnetic clasp, where the first connecting device and the second device are arranged such that they have opposing polarities when the first and second portions are properly aligned in straw functional straw configuration. In other embodiments, the first connecting device and the second connecting device may have complementary shaped protrusion(s) and recess(es) that may be pressure fit together when the first and second portions are properly aligned in straw functional straw configuration. For example, the connecting device of the present invention may include complementary pressure fitting male and female connectors on each of the portions of the straw (e.g., tongue-and-groove-style connectors). In other examples, the connecting mechanism may be a clasp on a first portion of the straw that applies pressure to the exterior surface of the second portion of the straw when the straw is assembled. Other connecting mechanisms are contemplated within the scope of the present invention as well.

In another aspect, the present invention relates to a method of using a washable straw, comprising separating a first connectable portion of the washable straw having a first clasping element from a second connectable portion having a second clasping element to expose an interior of the washable straw; washing the interior portion of the washable straw, wherein an inner side of the first connectable portion and an inner side of the second connectable portion are accessible when the first connectable portion and the second connectable portion are separated, and the first connecting surface and the second connecting surface are non-planar and complementary; and reconnecting the first connectable portion and the second connectable portion of the washable straw by connecting the first clasping element to the second clasping element.

In some embodiments, the two portions of the straw may be connected to each other by a joint. In some embodiments, the joint may be a hinge-type joint, such as a hinge that is integrally formed with the two portions of the straw. In other embodiments, the hinge joint may include integrated knuckles and a pin (like a Butt hinge). The hinge joint may allow the portions of the straw to be held together.

### BRIEF DESCRIPTION OF THE DRAWINGS

FIGS. 1-14 provide views of a straw according to an embodiment of the present invention.

FIGS. 15-28 provide views of a straw according to an embodiment of the present invention.

FIGS. 29-42 provide views of a straw according to an embodiment of the present invention.

FIGS. 43-56 provide views of a straw according to an embodiment of the present invention.

### DETAILED DESCRIPTION OF THE DRAWINGS

Reference will now be made in detail to certain embodiments of the invention, examples of which are illustrated in the accompanying drawings. While the invention will be described in reference to these embodiments, it will be understood that they are not intended to limit the invention. To the contrary, the invention is intended to cover alternatives, modifications, and equivalents that are included within the spirit and scope of the invention as defined by the claims. In the following disclosure, specific details are given to provide a thorough understanding of the invention. However, it will be apparent to one skilled in the art that the present invention may be practiced without these specific details.

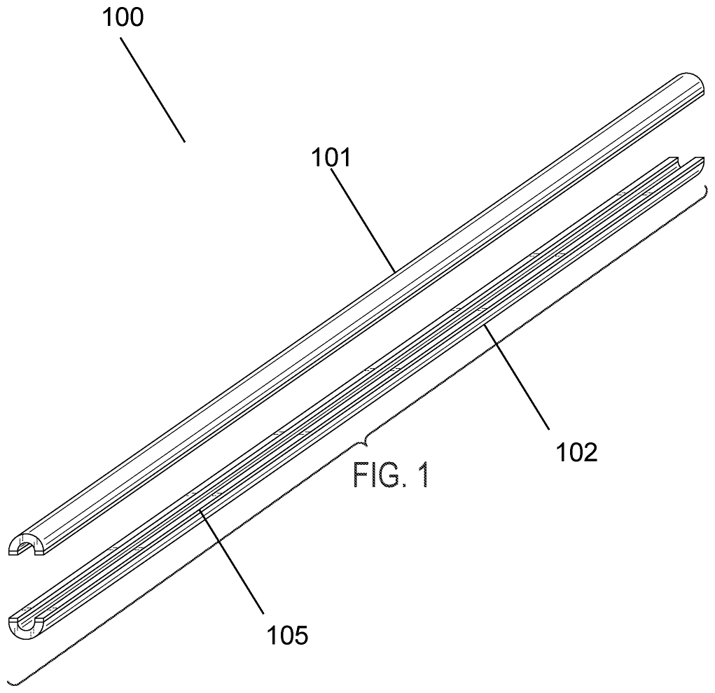

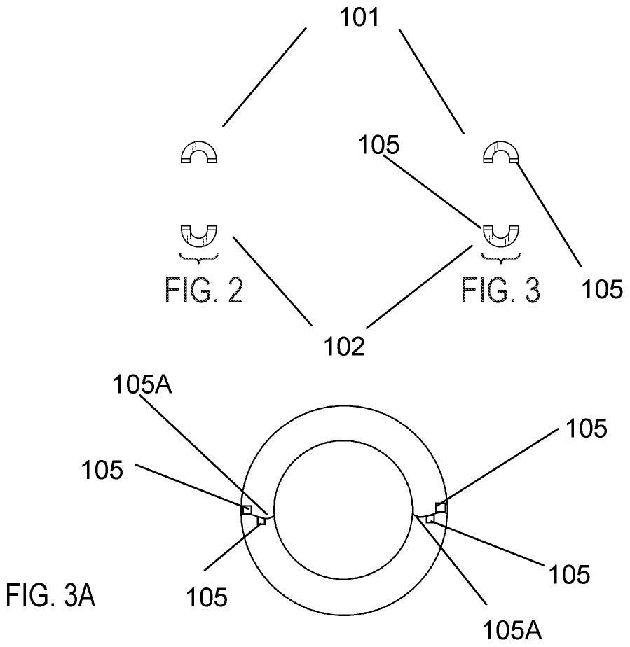

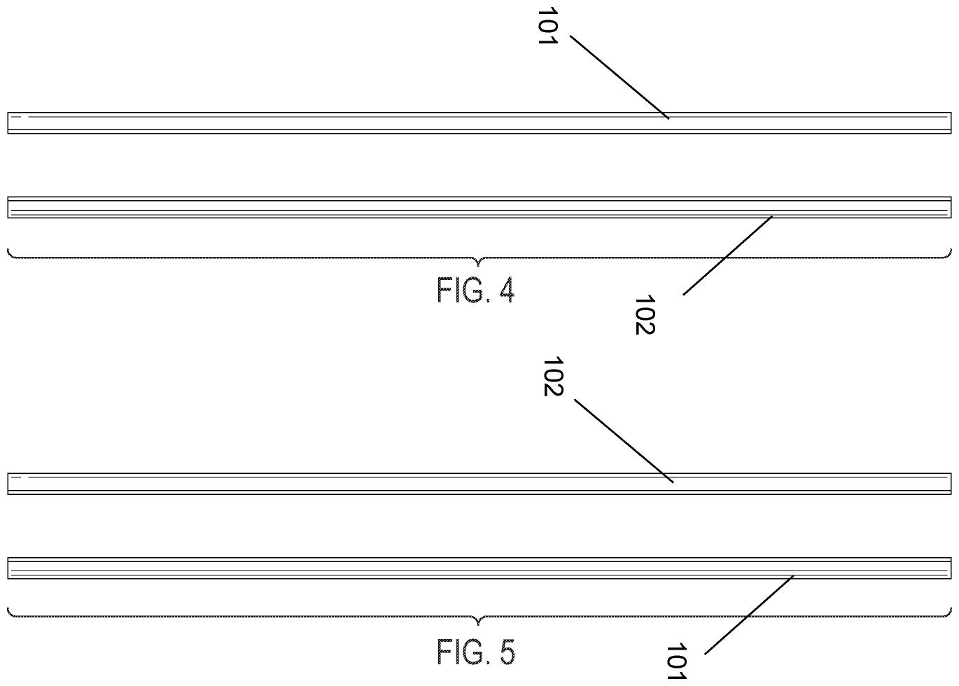

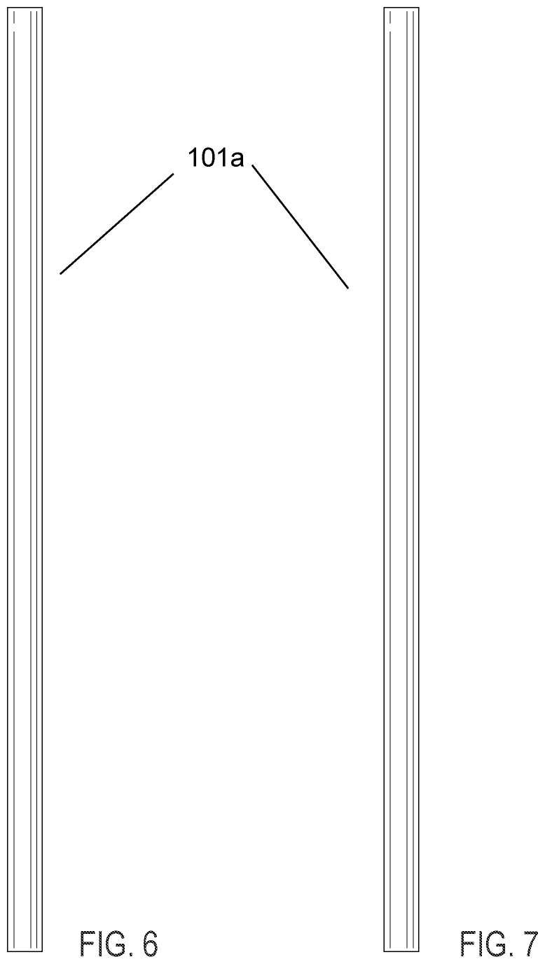

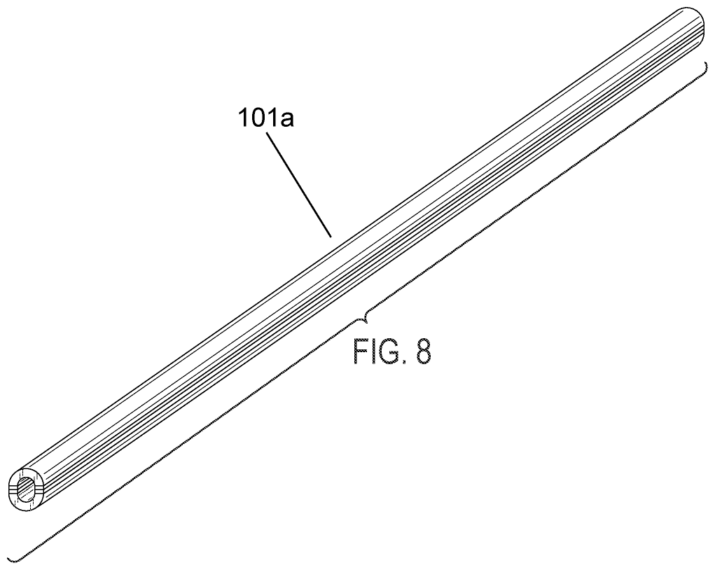

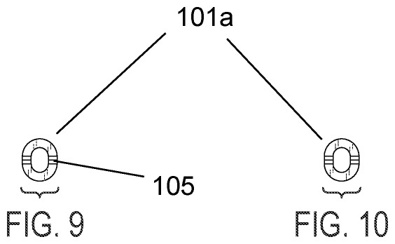

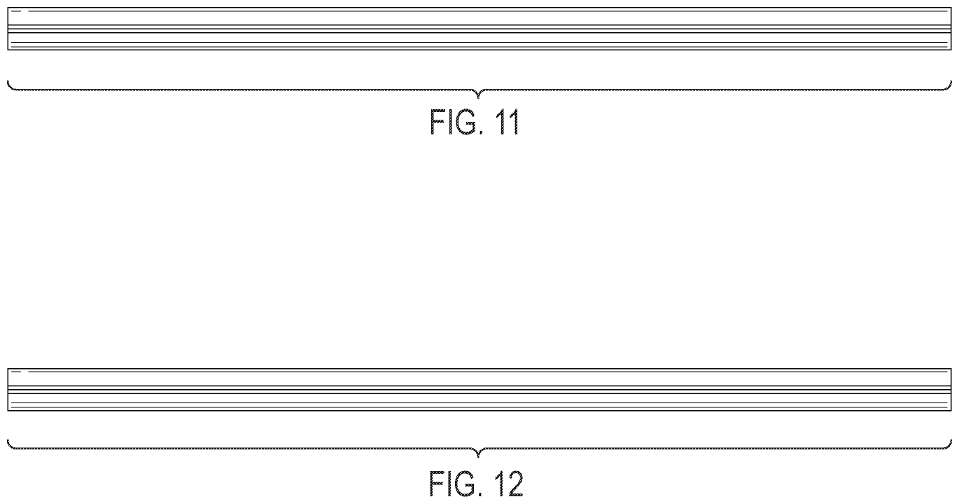

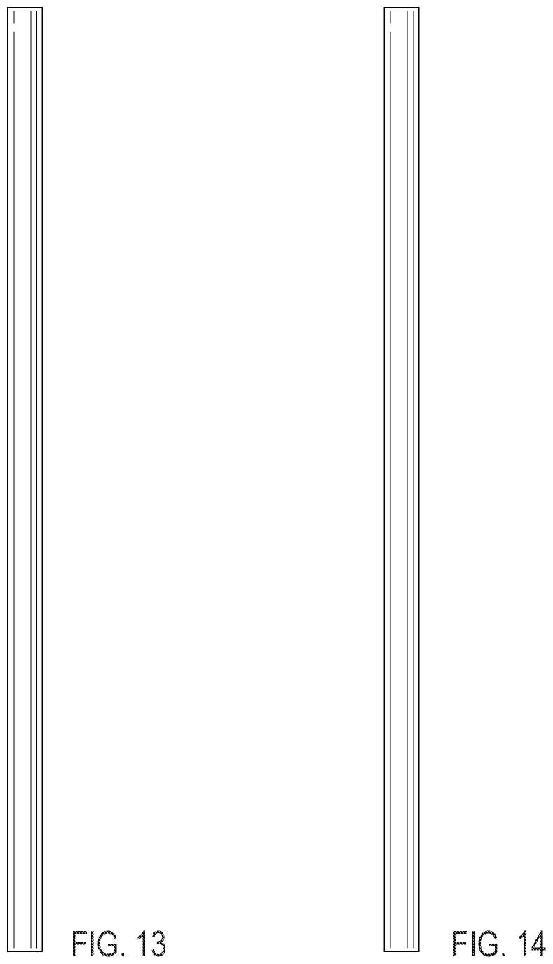

As demonstrated in FIGS. 1-14, in some embodiments the straw 100 may include a first portion 101 and second portion 102 that are complementary to one another and can be combined into a functioning assembled straw 100a. The portions 101 and 102 may be connected and held together by a connecting mechanism 105 in surfaces 105A. The connecting mechanism 105 may include complementary magnetic strips of opposing polarities that cause the magnets to be drawn together. In some embodiments, the magnets may be included in curved, complementary interfacing surfaces 105A. For example, the interfacing surfaces may have a roughly sinusoidal curving surface to create more surface area between the two portions 101 and 102 of the straw and thus better frictional interaction between the two portions 101 and 102 of the straw. In such embodiments, the surfaces 105A may have a plurality of magnets (e.g., magnetic strips) in different curved portions of each surface 105A in order to allow the magnets to be embedded therein without creating substantial irregularities in the surface curvature of surfaces 105A. Having multiple magnetic strips may also create magnetic connections in differing and intersecting planes, which may enhance the strength of the connection between portions 101 and 102. See, e.g., FIG. 3A providing a cross-section view

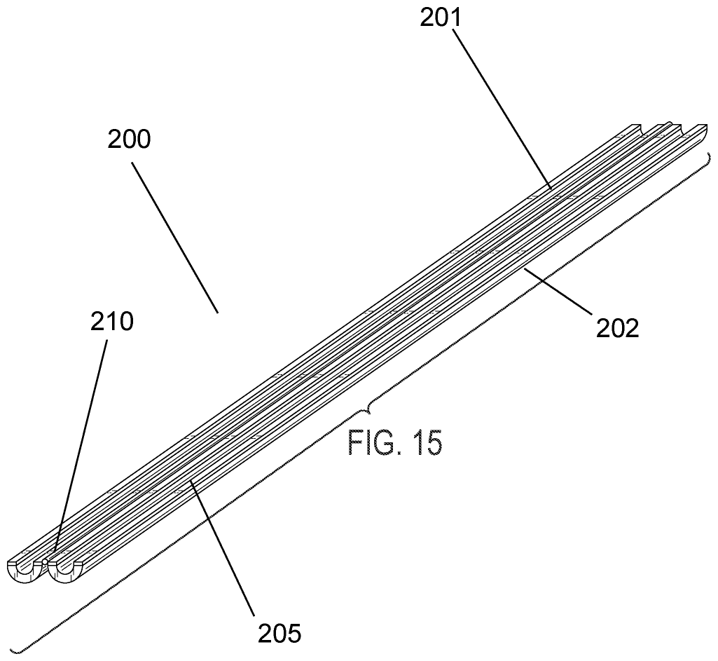

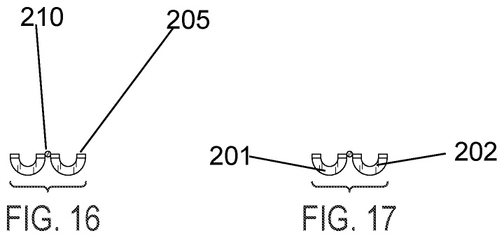

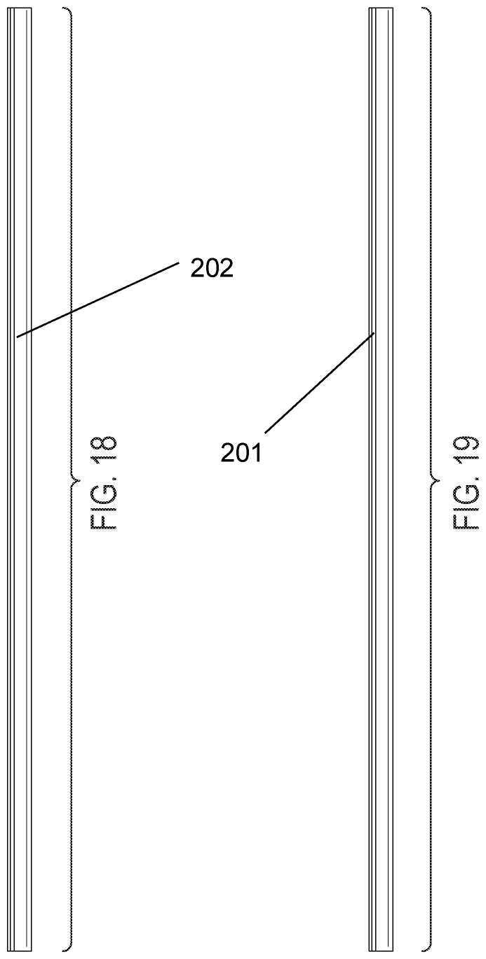

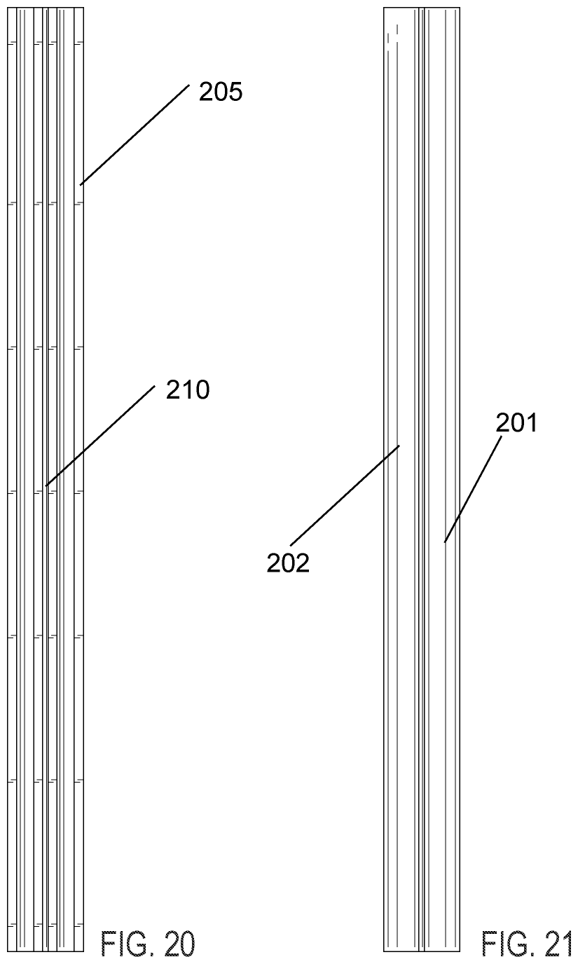

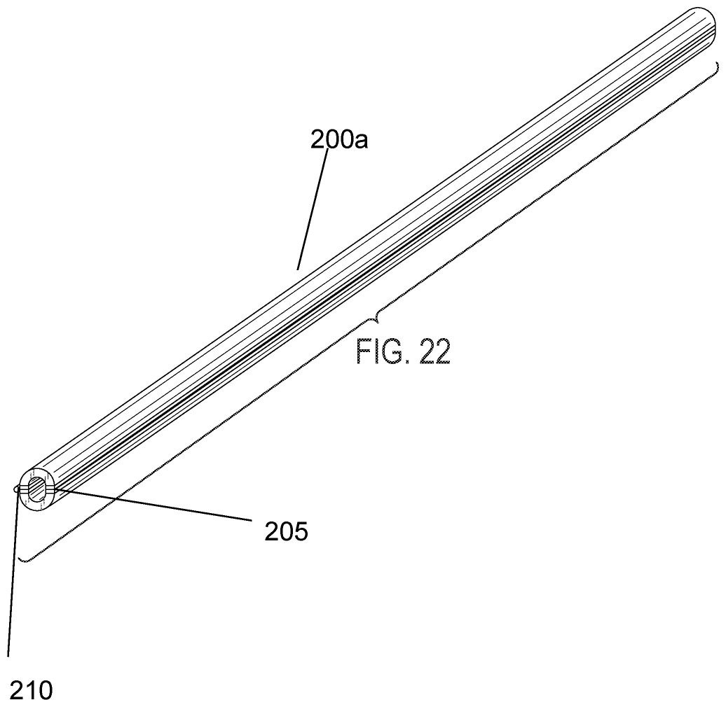

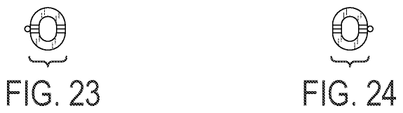

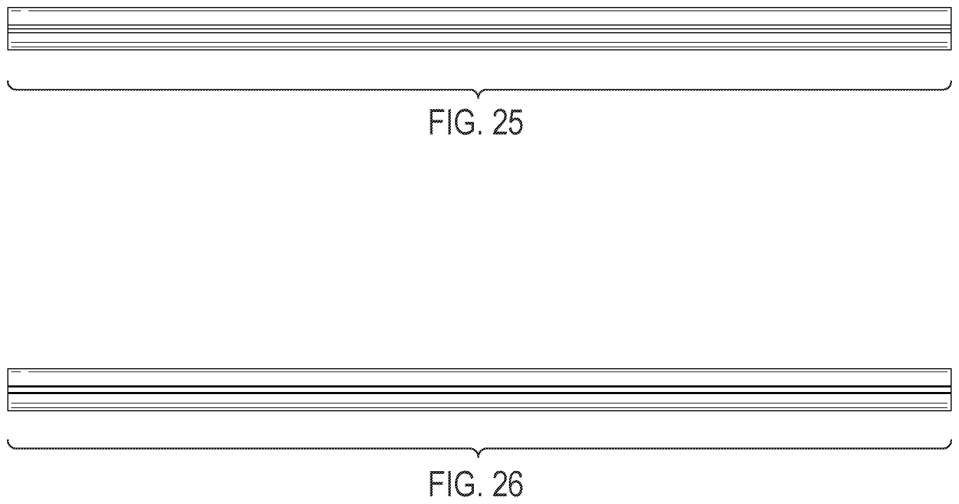

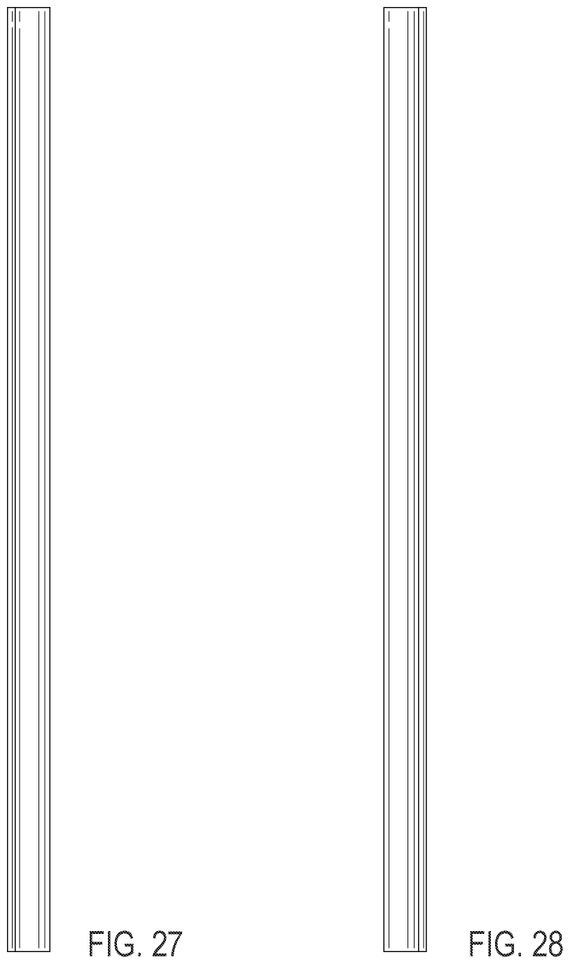

As demonstrated in FIGS. 15-28, in some embodiments the straw 200 may include a first portion 201 and second portion 202 that are complementary to one another and can be combined into a functioning assembled straw 200a. The portions 101 and 102 may be connected by a hinge joint 210 that allows the straw 200 to be opened by pivoting the two portions 101 and 102 around the hinge 210. When the straw 200a is closed, it may be held together by a connecting mechanism 205. The connecting mechanism 205 may include complementary magnetic strips of opposing polarities that cause the magnets to be drawn together.

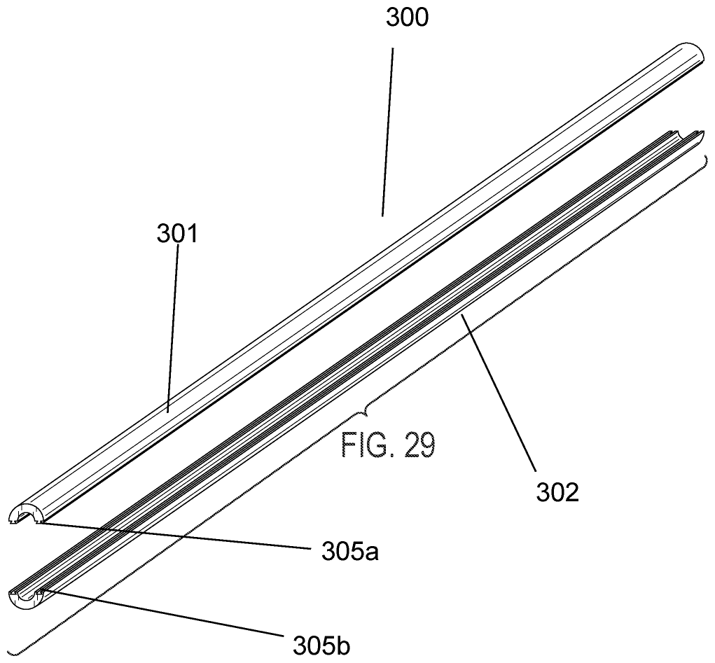

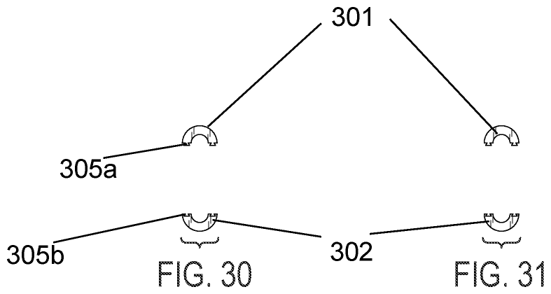

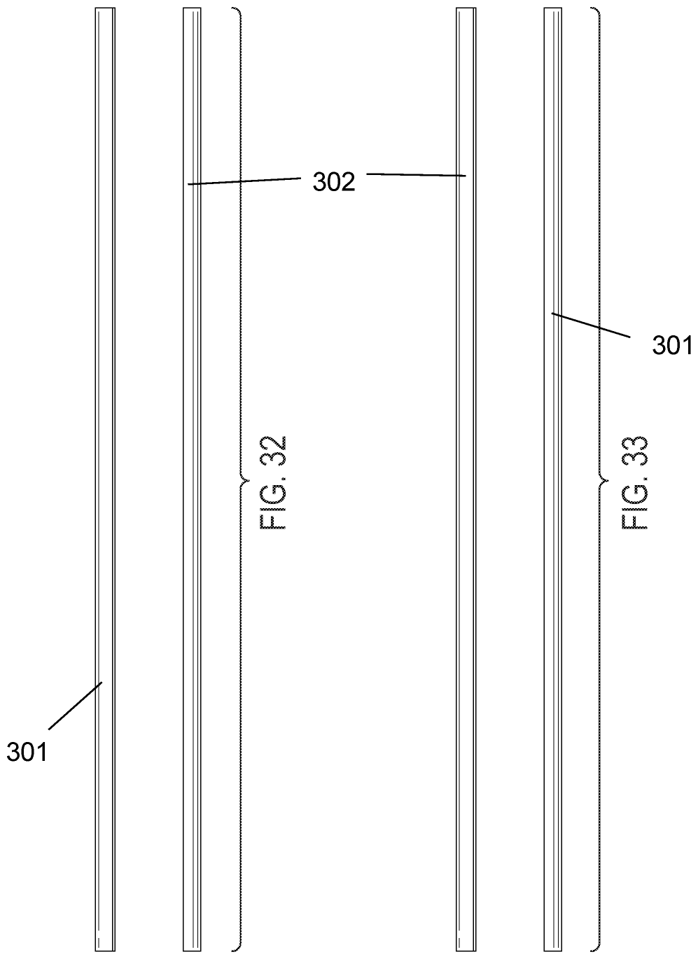

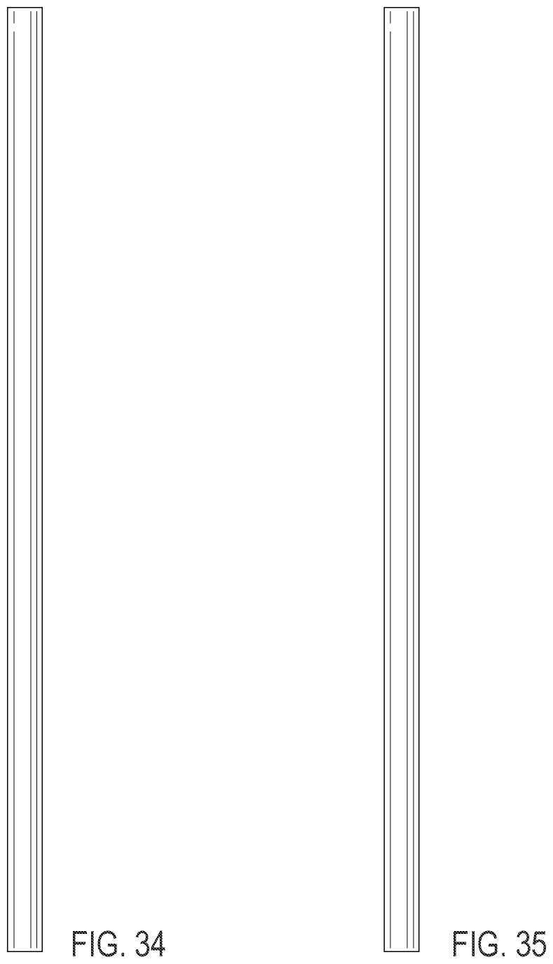

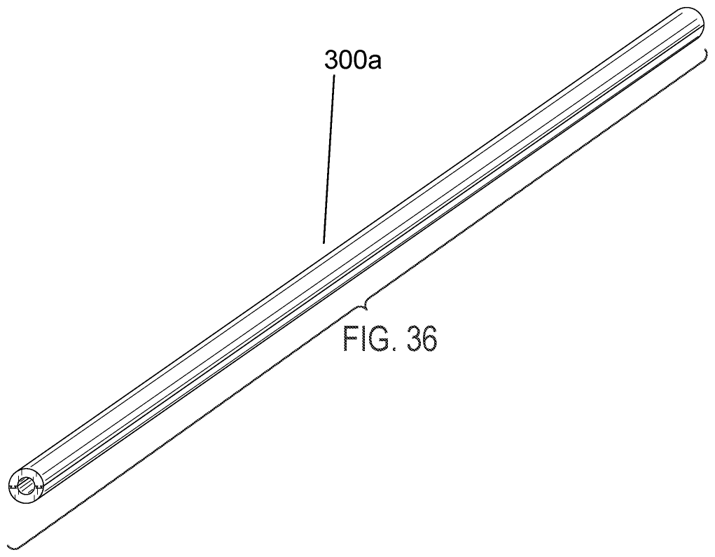

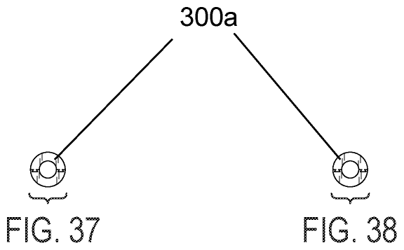

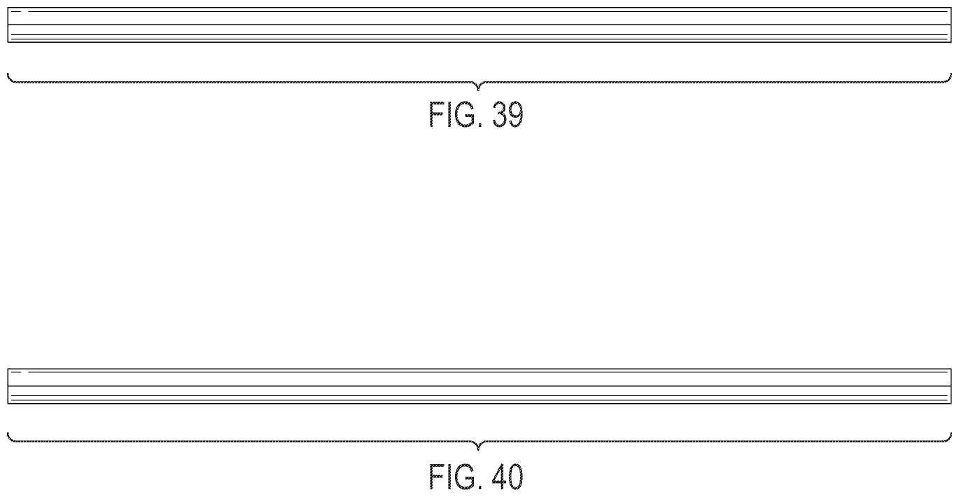

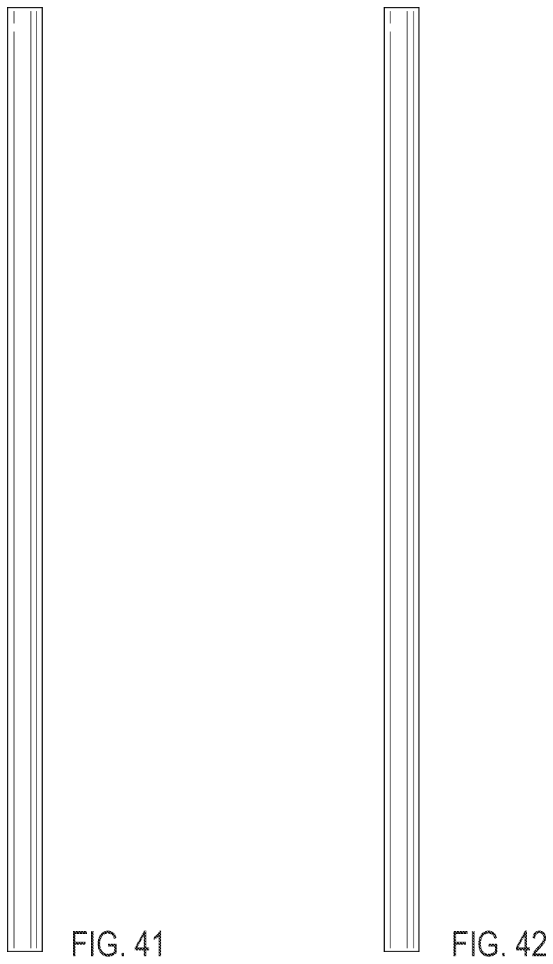

As demonstrated in FIGS. 29-42, in some embodiments the straw 300 may include a first portion 301 and second portion 302 that are complementary to one another and can be combined into a functioning assembled straw 300a. The portions 301 and 302 may be connected and held together by a connecting mechanism 305. The connecting mechanism 305 may include complementary pressure fitting male and female connectors 305a and 305b (tongue-and-groove-style connectors). In some embodiments, the connection surfaces (e.g., 305A and 305B) may have a plurality of magnets (e.g., magnetic strips) thereon, with different portions of the connection surfaces have separate magnets. The magnets may be embedded therein without creating substantial irregularities in the surfaces. Having multiple magnetic strips may also create magnetic connections in differing planes, which may enhance the strength of the connection between portions 301 and 302.

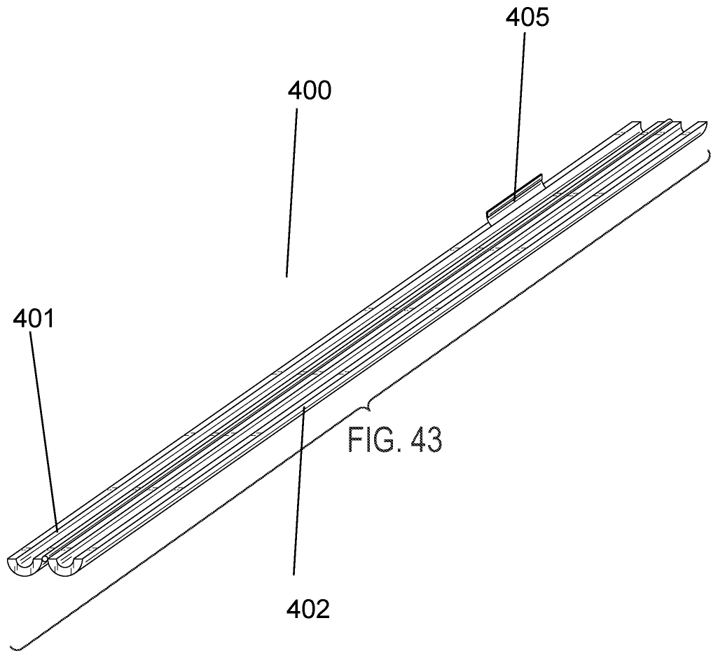

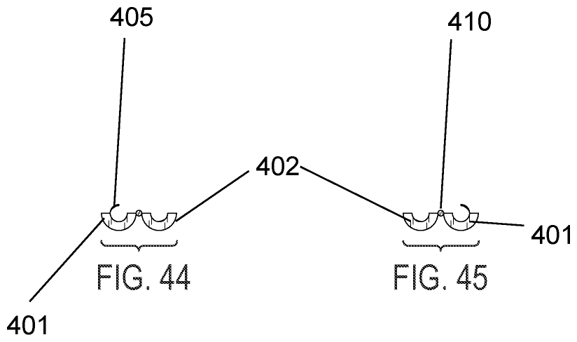

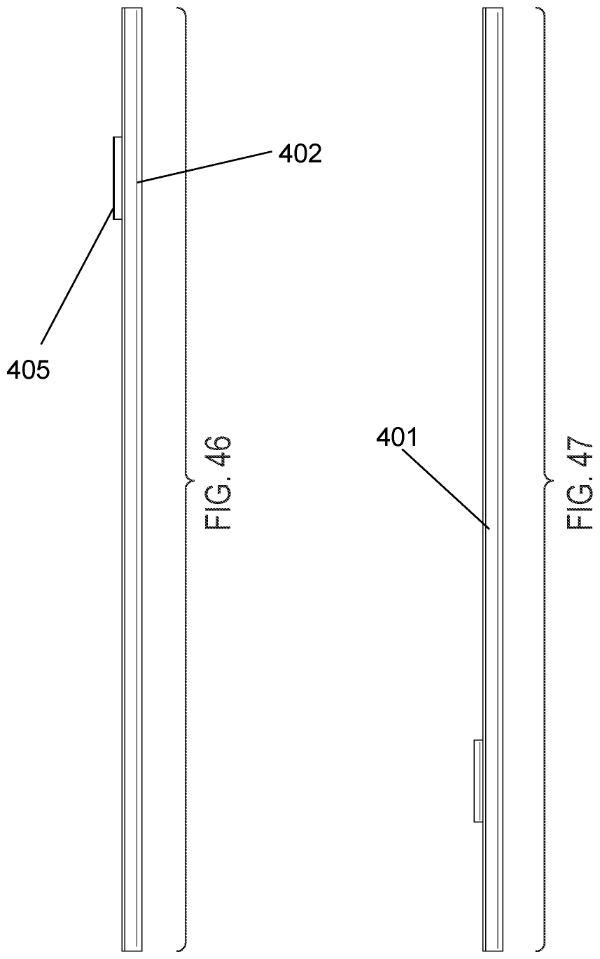

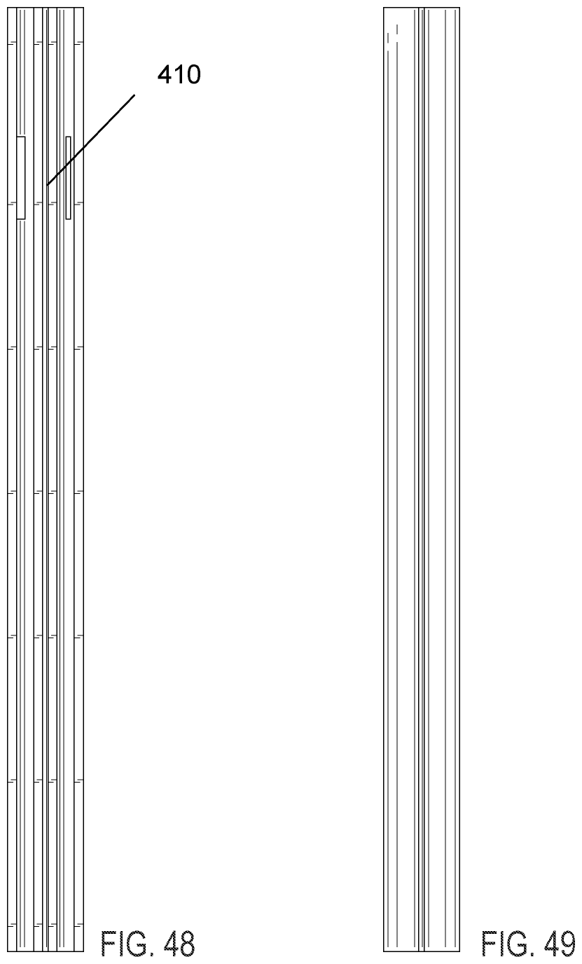

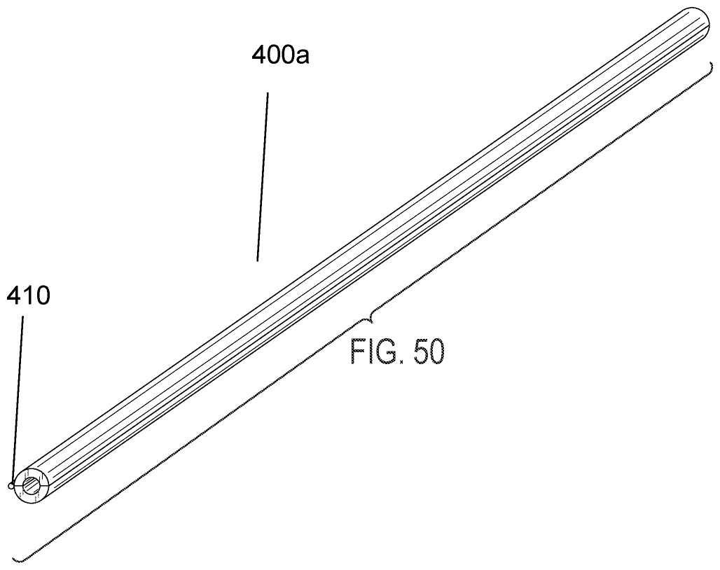

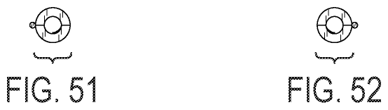

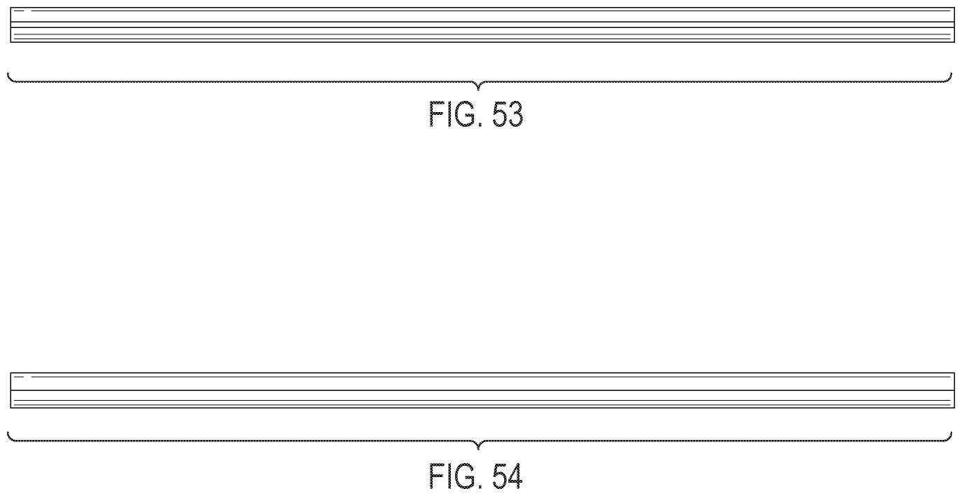

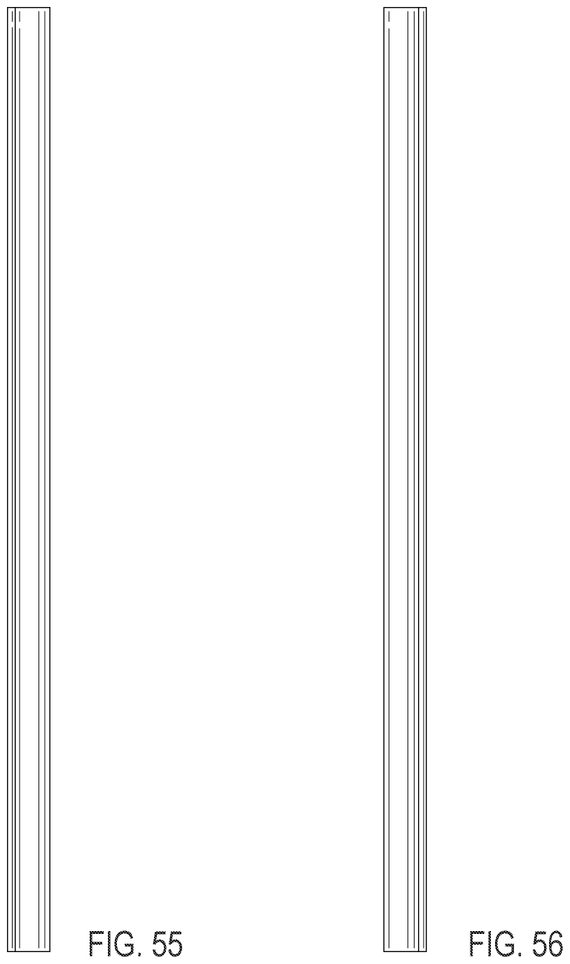

As demonstrated in FIGS. 43-56, in some embodiments the straw 400 may include a first portion 401 and second portion 402 that are complementary to one another and can be combined into a functioning assembled straw 400a. The portions 401 and 402 may be connected by a hinge joint 410 that allows the straw 400 to be opened by pivoting the two portions 401 and 402 around the hinge 410. When the straw 400a is closed, it may be held together by a connecting mechanism 405. The connecting mechanism 405 may include a clasp on the portion 401 that grasps the exterior surface of the portion 402 to hold the assembled straw 400a together.

It should also be understood that the foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

What is claimed:

1. A washable straw, comprising:
a. a first connectable portion having a first clasping element; and
b. a second connectable portion having a second clasping element operable to be connected to the first clasping element to connect said first connectable portion to said second connectable portion.

2. The washable straw according to claim 1, wherein an inner side of the first connectable portion and an inner side of the second connectable portion are accessible when said first connectable portion and said second connectable portion are separated.

3. The washable straw according to claim 1, the first clasping element is magnetic and the second clasping element is magnetic and aligns with opposite polarity with the first clasping element.

4. The washable straw according to claim 1, the first clasping element is a snap-fitting and said second clasping element is a snap-fitting element having a shape that is complementary to a shape of the first clasping element, such that the first and second clasping members are configured to snap fit and connect to each other.

5. The washable straw according to claim 1, wherein the first connectable portion has a first interconnecting surface, and the second connectable portion has a second interconnecting surface.

6. The washable straw according to claim 5, wherein said first connecting surface and said second connecting surface are non-planar and complementary.

7. The washable straw according to claim 1, further comprising a pivot connection mechanism between said first connectable portion and said second connectable portion.

8. The washable straw according to claim 3, further comprising a pivot connection mechanism between said first connectable portion and said second connectable portion.

9. The washable straw according to claim 4, further comprising a pivot connection mechanism between said first connectable portion and said second connectable portion.

10. The washable straw according to claim 4, further comprising at least one first magnetic element in a surface of said first clasping element and at least one second magnetic element for the second clasping element.

11. A washable straw, comprising:
a. a first connectable portion having a first clasping element; and
b. a second connectable portion having a second clasping element operable to be connected to the first clasping element to connect said first connectable portion to said second connectable portion, and an inner side of the first connectable portion and an inner side of the second connectable portion are accessible when said first connectable portion and said second connectable portion are separated, and said first connecting surface and said second connecting surface are non-planar and complementary.

12. The washable straw according to claim 11, the first clasping element is magnetic and the second clasping element is magnetic and aligns with opposite polarity with the first clasping element.

13. The washable straw according to claim 11, the first clasping element is a snap-fitting and said second clasping element is a snap-fitting element having a shape that is complementary to a shape of the first clasping element, such that the first and second clasping members are configured to snap fit and connect to each other.

14. The washable straw according to claim 11, wherein the first connectable portion has a first interconnecting surface, and the second connectable portion has a second interconnecting surface.

15. The washable straw according to claim 11, further comprising a pivot connection mechanism between said first connectable portion and said second connectable portion.

16. The washable straw according to claim 11, further comprising a pivot connection mechanism between said first connectable portion and said second connectable portion.

17. The washable straw according to claim 11, further comprising a pivot connection mechanism between said first connectable portion and said second connectable portion.

18. The washable straw according to claim 4, further comprising at least one first magnetic element in a surface of said first clasping element and at least one second magnetic element for the second clasping element.

19. A method of using a washable straw, comprising:
a. separating a first connectable portion of said washable straw having a first clasping element from a second connectable portion having a second clasping element to expose an interior of said washable straw;
b. washing said interior portion of said washable straw, wherein an inner side of the first connectable portion and an inner side of the second connectable portion are accessible when said first connectable portion and said second connectable portion are separated, and said first connecting surface and said second connecting surface are non-planar and complementary; and
c. reconnecting said first connectable portion and said second connectable portion of said washable straw by connecting said first clasping element to said second clasping element.

20. The method of claim 19, the first clasping element is magnetic and the second clasping element is magnetic and aligns with opposite polarity with the first clasping element.
